(19) United States
(12) Patent Application Publication
(10) Pub. No.: US 2018/0010535 A1
(43) Pub. Date: Jan. 11, 2018

(54) INJECTION DEVICE FOR AN INTERNAL COMBUSTION ENGINE

(71) Applicant: Robert Bosch GmbH, Stuttgart (DE)

(72) Inventors: Andreas Posselt, Muehlacker (DE); Thomas Pauer, Freiberg (DE)

(21) Appl. No.: 15/549,351

(22) PCT Filed: Jan. 19, 2016
(86) PCT No.: PCT/EP2016/051008

§ 371 Date: Aug. 7, 2017

(30) Foreign Application Priority Data
Feb. 9, 2015 (DE) 102015202218.8

(51) Int. Cl. F02D 41/00; F02B 47/02; F02D 19/06; F02D 41/30

(52) U.S. Cl. CPC F02D 41/0025; F02D 41/3094; F02D 41/3064; F02B 47/02; F02D 19/061; F02D 19/0639

(57) ABSTRACT

An injection device for an internal combustion engine, the internal combustion engine including a combustion chamber and at least one intake manifold, the injection device including a first injector for injecting a fuel directly into the combustion chamber, and the injection device including a second injector for injection into the intake manifold, wherein the second injector is configured to inject water.

### FIELD OF THE INVENTION

The present invention is directed to an injection device for an internal combustion engine.

### BACKGROUND INFORMATION

Injection devices for an internal combustion engine for injecting a fuel into an intake manifold, or for injecting a fuel directly into the combustion chamber, are generally known. To achieve a reduction in the fuel consumption at full load of the internal combustion engine through efficiency improvement and to achieve a knock reduction, water is injected via a further injector. Although the consumption of the internal combustion engine may be reduced by a further injector for injecting water, no reduction in the particulate emission at partial load of the internal combustion engine is achieved.

### SUMMARY OF THE INVENTION

The injection device according to the present invention for an internal combustion engine as recited in the subordinated claims has the advantage over the related art that both a reduction in the fuel consumption during operation of the internal combustion engine at full load and a reduction in the particulate emission during operation of the internal combustion engine at partial load are achieved. The reduction in the fuel consumption during operation of the internal combustion engine is achieved through efficiency improvements of the basic engine, and by injecting water into an intake manifold at full load of the internal combustion engine for knock reduction. The internal combustion engine has a first injection path for injecting a fuel, a second injection path for injecting water, and a third injection path for injecting either the fuel (i.e., the same fuel used also in the first injection path) or for injecting a further fuel. The reduction in particulate emission during operation of the internal combustion engine at partial load is made possible by the presence of a third injection path for injecting the fuel or the further fuel. The injection device according to the present invention advantageously enables both a reduction in the fuel consumption of the internal combustion engine due to optimized full load and a reduction in the particulate emission at partial load of the internal combustion engine. Since both a reduction in the fuel consumption and a reduction in the particulate emission are required by law in many regions, great demand exists in this regard. The internal combustion engine may be configured as a gasoline engine for a motor vehicle, which may be an automobile. The internal combustion engine may include more than one cylinder, each of the cylinders having a combustion chamber including at least one first and one second injector. According to the present invention, the injection device includes the first injector for direct injection into the combustion chamber, and at least the second injector for injection into the intake manifold, the second injector being provided for the injection of water.

Advantageous embodiments and refinements of the present invention may be derived from the descriptions herein as well as from the description with reference to the drawings.

According to one refinement, it is provided that the second injector:
is configured to optionally inject either water, or the fuel or the further fuel, or
is configured to simultaneously inject both water and the fuel or the further fuel.

The injection device according to the present invention has three injection paths: a first injection path for injecting a fuel, a second injection path for injecting water, and a third injection path for injecting a fuel or another fuel different therefrom. According to one specific embodiment of the present invention, the three injection paths are implemented in that the injection device has a first injector for injecting a fuel directly into a combustion chamber and a second injector for optionally injecting either water or the fuel (or a further fuel). The first injection path is implemented by the first injector, and both the second injection path and the third injection path are implemented by the second injector (however, at different times), in that optionally water is injected via the second injector (at a first point in time) or fuel is injected via the second injector (at a second point in time), either the fuel (used in the first injector) or a further fuel being injected as such a fuel.

According to one alternative specific embodiment of the present invention, the three injection paths are implemented in that the second injector is configured to simultaneously inject both water—on the one hand—and the fuel or the further fuel—on the other hand, i.e., the second injection path and the third injection path are—at least partially—implemented simultaneously by the second injector in that a water/fuel mixture is injected by the second injector.

According to one further specific embodiment of the present invention, the second injector is in particular configured as a single injector or as a twin injector.

According to one further refinement, it is provided that the injection device includes a third injector for injecting the fuel (used in the first injector) or the further fuel or a third fuel into the intake manifold or into a further intake manifold. The first injection path is implemented by the first injector, the second injection path is implemented by the second injector, and the third injection path is implemented by the third injector.

In particular, it is provided according to one specific embodiment including three injectors that the fuel is directly injected into the combustion chamber via the first injector, and water (i.e., only water, and no fuel) is injected via the second injector, while the fuel (used in the first injector) or the further fuel is injected via the third injector.

In particular, it is provided according to one further specific embodiment including three injectors that the fuel is directly injected into the combustion chamber via the first injector, and a third fuel is injected via the third injector, while either optionally water and the further fuel are injected, or water and the further fuel are simultaneously injected, via the second injector.

According to one further refinement, it is provided:
that the first injector is a main injector and both the second and third injectors are secondary injectors; or
that the first and second injectors are secondary injectors and the third injector is a main injector, the main injector injecting a larger amount of fuel and/or having a longer operating time than the secondary injector. In this way, it is advantageously made possible that the further fuel and the third fuel may be injected in addition to the fuel, the main injector injecting a larger amount of fuel and/or having a longer operating time than the secondary injector. In this way, it is advantageously made possible that—when using the same fuel in the main injector and in a secondary injector—the main injector may be dimensioned to be smaller, whereby the fuel amount may be better adapted to the corresponding load situation. Due to the smaller dimensioning of the main injector, it is possible, where previously, in certain load situations, only a larger amount of fuel than necessary could be injected due to the dimensioning of the main injector, to reduce the particulate emission since the injected fuel amount may be better adapted to the fuel amount required in the corresponding load situation, and injector-specific design features may also be utilized for improved spray preparation. The operating strategy and the system design and supply of the fuel, the further fuel and/or the water, and the supply of the third fuel, may be adapted to segment-specific or market-specific requirements.

According to one further specific embodiment, it is specifically provided that the fuel is a gasoline fuel and/or a flex fuel, the first injector being configured as the main injector for injecting the fuel and the second injector being configured as the secondary injector for optionally injecting the fuel or for injecting water. The first injection path is implemented by the first injector, and both the second injection path and the third injection path are implemented by the second injector (however, at different times), in that optionally water is injected via the second injector (in particular, at a point in time at which the internal combustion engine is at the full load operating point or at an operating point close to full load—in particular for knock reduction) or the fuel is injected via the second injector (in particular, at a point in time at which the internal combustion engine is at a partial load operating point—in particular for particulate reduction). It is advantageously possible according to the present invention that a coupled control of the second injector is implemented via a shut-off valve and the activation of a water pump. The second injector then must be configured for both media. Within the scope of the present invention, in particular fuels according to the designations E0-E85, E22-E100, and M15-M100 are considered flex fuels. According to this specific embodiment, the second injector may in particular be used to lower emissions in the cold start/warm-up range.

According to one further specific embodiment, it is specifically provided that
either the fuel is a gasoline fuel and/or a flex fuel,
or the fuel is a CNG fuel or an LPG fuel, the first injector being configured to inject the fuel, the second injector being configured to inject water, and the third injector being configured to inject the fuel. It is advantageously possible according to the present invention that the operation of the third injector and the operation of the second injector are autonomously implemented according to a decoupled control; in particular, a specific design of the third injector and of the second injector is possible. A suitable operating strategy is, in particular, that the third injector is used in the partial load operation for particulate reduction and, if necessary, at a full load operating point or at an operating point close to full load, to increase the amount of the fuel, while the second injector is used for knock reduction at a full load operating point or at an operating point of the internal combustion engine close to full load. According to this specific embodiment, the third injector may in particular be used to reduce emissions in the cold start/warm-up range.

According to one further specific embodiment, it is specifically provided that
either the fuel is a gasoline fuel and/or a flex fuel, and the further fuel is a CNG fuel (compressed natural gas) or an LPG fuel (liquefied petroleum (natural) gas),
or the fuel is a CNG fuel or an LPG fuel, and the further fuel is a gasoline fuel and/or a flex fuel, the first injector being configured to inject the fuel, the second injector being configured to inject water, and the third injector being configured to inject the further fuel. According to the present invention, in this way a combination of a bi-fuel injection system with water injection is made possible.

According to one further specific embodiment, it is specifically provided that
either
the fuel is a gasoline fuel and/or a flex fuel, and
the further fuel is an ethanol fuel and/or a methanol fuel, and
the third fuel is a CNG fuel or an LPG fuel or an alcohol fuel,
or
the fuel is a CNG fuel or an LPG fuel or an alcohol fuel, and
the further fuel is an ethanol fuel and/or a methanol fuel, and
the third fuel is a gasoline fuel and/or a flex fuel, the first injector being configured to inject the fuel, the third injector being configured to inject the third fuel, and the second injector
being configured to optionally inject the further fuel or to inject water, or
to simultaneously inject both water and the further fuel. According to the present invention, in this way a tri-fuel/water injection system is made possible.

According to one further refinement, it is provided that a control unit controls the injection amount of the first injector, the injection amount of the second injector and/or the injection amount of the third injector as a function of the load of the internal combustion engine and further operating parameters of the internal combustion engine. In this way, it is advantageously made possible that the amount of the injected fuel and/or the amount of the injected further fuel and/or the amount of the injected third fuel, and the amount of the injected water, may be adapted as a function of the load of the internal combustion engine and further operating parameters.

According to one further refinement, it is provided that the fuel, the further fuel and the third fuel are one of the following fuels:
gasoline, or
liquefied petroleum gas (LPG), or
compressed natural gas (CNG), or
alcohols, which may be methanol and/or ethanol, or
flex fuel, in particular mixtures of ethanol and gasoline (such as E0-E85, E22-E100) or mixtures of methanol and gasoline (M15-M100), or
gasoline and flex fuel. In this way, it is advantageously made possible that the internal combustion engine may be operated with one fuel, with two different fuels or with three different fuels.

### BRIEF DESCRIPTION OF THE DRAWINGS

FIG. 1 shows an injection device for an internal combustion engine according to a first exemplary specific embodiment of the present invention in a schematic representation.

FIG. 2 shows an injection device for an internal combustion engine according to a second exemplary specific embodiment of the present invention in a schematic representation.

FIG. 3 shows an injection device for an internal combustion engine according to a third exemplary specific embodiment of the present invention in a schematic representation.

### DETAILED DESCRIPTION

Identical parts are always denoted by the same reference numerals in the various figures and are therefore generally also cited or mentioned only once.

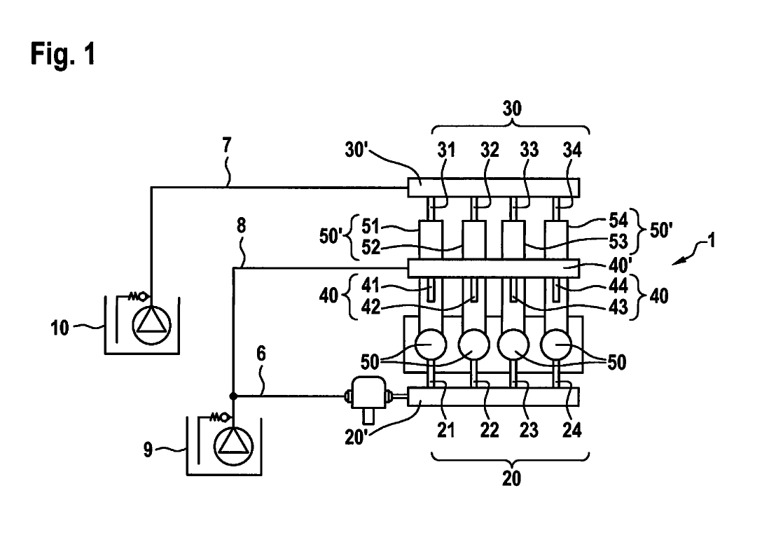

Injection devices 1 shown in FIGS. 1 through 3 each include a first injector 20 and a second injector 30—for each cylinder of the internal combustion engine. According to the present invention, the internal combustion engine includes multiple cylinders, such as two, three, four, five, six, eight, ten or twelve cylinders. In FIGS. 1 through 3, four cylinders 50 of the internal combustion engine are indicated in each case by way of example; however, these are not individually provided with different reference numerals. Each of cylinders 50 includes a combustion chamber including at least one associated intake manifold. The respective intake manifold of each of the four cylinders 50 is denoted by reference numerals 51, 52, 53 and 54 in FIGS. 1 through 3, these reference numerals being combined by reference numeral 50′. The respective first injector 20 of each of the four cylinders 50 is denoted by reference numerals 21, 22, 23 and 24 in FIGS. 1 through 3, these reference numerals being combined by reference numeral 20. The respective second injector 30 of each of the four cylinders 50 is denoted by reference numerals 31, 32, 33 and 34 in FIGS. 1 through 3, these reference numerals being combined by reference numeral 30. According to the present invention, in particular, a first pressure accumulator 20′, from which a stored medium (fuel) is supplied to the respective first injectors 21, 22, 23, 24, is assigned to the respective first injectors 21, 22, 23, 24. According to the present invention, in particular, a second pressure accumulator 30′, from which a stored medium (water and/or either the fuel or a further fuel) is supplied to the respective second injectors 31, 32, 33, 34, is accordingly assigned to the respective second injectors 31, 32, 33, 34.

FIG. 1 shows an injection device 1 for an internal combustion engine according to a first exemplary specific embodiment of the present invention. According to the first specific embodiment, the internal combustion engine or injection device 1—per cylinder—includes a third injector 40, in addition to first and second injectors 20, 30. The respective third injector 40 of each of the four cylinders 50 shown in FIG. 1 is denoted by reference numerals 41, 42, 43 and 44 in FIG. 1, these reference numerals being combined by reference numeral 40. According to the present invention, in particular, a third pressure accumulator 40′, from which a stored medium (fuel or further fuel) is supplied to the respective third injectors 41, 42, 43, 44, is assigned to the respective third injectors 41, 42, 43, 44.

According to the first specific embodiment shown in FIG. 1, the internal combustion engine or injection device 1 includes a first injection path 6 for injecting fuel (such as gasoline and/or flex fuel or also a CNG fuel or an LPG fuel) directly into the combustion chamber of each of cylinders 50 with the aid of first injector 20. Furthermore, the internal combustion engine or injection device 1 includes a second injection path 7 for injecting water into the respective intake manifold 50′ of each of cylinders 50, and a third injection path 8 for injecting the fuel (such as gasoline and/or flex fuel or also a CNG fuel or an LPG fuel) directly into an intake manifold. The fuel is supplied to first injection path 6 and third injection path 8 with the aid of a fuel pump 9. Water is supplied to second injection path 7 with the aid of a water pump 10.

According to the present invention, first injector 20 is, in particular, a main injector for directly injecting the fuel (such as gasoline and/or flex fuel or also a CNG fuel or an LPG fuel) into the combustion chamber of a cylinder 50. According to the present invention, second injector 30 is, in particular, a secondary injector for injecting water into the intake manifold of cylinder 50. According to the present invention, third injector 40 is, in particular, a secondary injector for injecting the fuel (such as gasoline and/or flex fuel or also a CNG fuel or an LPG fuel) into the intake manifold of cylinder 50 or into a further intake manifold (not shown) of cylinder 50. According to one specific embodiment, cylinder 50 additionally includes one further second injector, this being a secondary injector for injecting water into the intake manifold or into the further intake manifold, in particular as a twin injector with the second injector.

A control unit controls the injection amount of first injector 20, the injection amount of second injector 30 and/or the injection amount of third injector 40 as a function of the load of the internal combustion engine and further operating parameters of the internal combustion engine. In this way, the injection of water and of the fuel (such as gasoline and/or flex fuel) may be carried out autonomously after decoupled control. In a partial load phase of the internal combustion engine, third injector 40 may be switched on. In this way, a reduction in the particulate emission is implemented. In a full load phase of the internal combustion engine, third injector 40 may be also switched on. In this way, an increase in the injected amount of fuel (such as gasoline and/or flex fuel or also a CNG fuel or an LPG fuel) is achieved. Furthermore, second injector 30 may be switched on in a full load phase of the internal combustion engine. The combustion chamber is thereby cooled, so that the efficiency of the internal combustion engine is advantageously increased in a suitable manner, and the knock resistance increases. During a cold start phase and/or warm-up phase of the internal combustion engine, third injector 40 may be switched on. In this way, an emission reduction is achieved.

According to one variant of the specific embodiment shown in FIG. 1 (however, this variant not being shown), the internal combustion engine or injection device 1 also includes first, second, and third injection paths 6, 7, 8; in contrast to the specific embodiment shown in FIG. 1, however, not the same fuel, but different fuels are injected via first and third injectors 20, 40: The first injection path is provided for injecting fuel directly into the combustion chamber of a cylinder 50 with the aid of first injector 20. Second injection path 7 is provided for injecting water into intake manifold 50′ of cylinder 50. Third injection path 8 is provided for injecting a further fuel (different from the first fuel) either into the intake manifold or into a further intake manifold. According to the present invention, it is in particular provided in this described variant that the fuel (injected via first injector 20) is a gasoline fuel and/or a flex fuel, and that the further fuel (injected via second injector 30) is a CNG fuel or an LPG fuel. Alternatively hereto, it is in particular provided in this described variant that the fuel (injected via first injector 20) is a CNG fuel or an LPG fuel, and that the further fuel (injected via second injector 30) is a gasoline fuel and/or a flex fuel.

According to this described variant, the internal combustion engine includes third injector 40. First injector 20 is, in particular a basic injector for directly injecting a fuel (such as gasoline and/or flex fuel) into the combustion chamber. Second injector 30 is a secondary injector for injecting water into the intake manifold. Third injector 40 is a basic injector for injecting the further fuel (such as liquefied petroleum gas or compressed natural gas) into the intake manifold or into a further intake manifold of cylinder 50. Furthermore, cylinder 50 may additionally include a further second injector, this being a secondary injector for injecting water into the intake manifold or into the further intake manifold, in particular as a twin injector with the second injector.

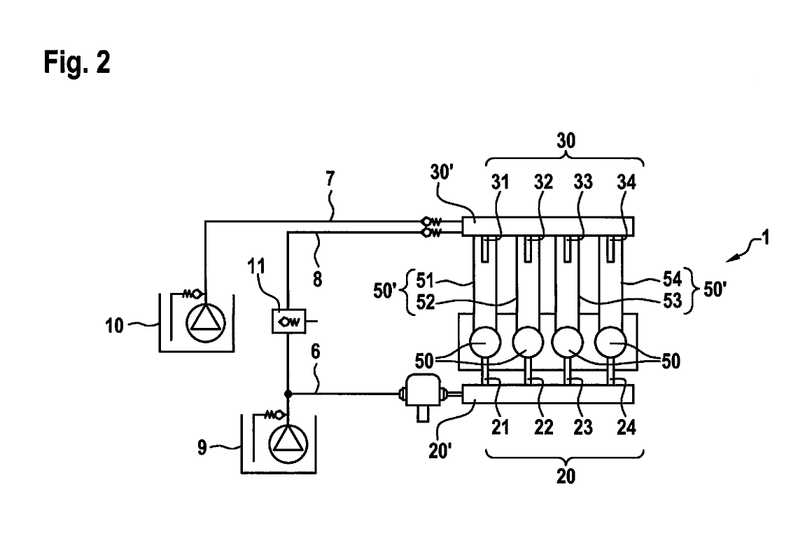

FIG. 2 shows an injection device 1 for an internal combustion engine according to a second exemplary specific embodiment of the present invention. The internal combustion engine includes a first injection path 6 for injecting a fuel (such as gasoline and/or flex fuel) directly into the combustion chamber, a second injection path 7 for injecting water into an intake manifold, and a third injection path 8 for injecting the fuel (such as gasoline and flex fuel) into the intake manifold. The fuel (such as gasoline and flex fuel) is supplied to first injection path 6 and third injection path 8 with the aid of a fuel pump 9. Water is supplied to second injection path 7 with the aid of a water pump 10. According to the present invention, it is provided that third injection path 8 is separated from first injection path 6 with the aid of a shut-off valve 11. First injector 2 is, in particular, a main injector for directly injecting the fuel (such as gasoline and flex fuel) into the combustion chamber. Second injector 30 is a secondary injector for injecting either water or the fuel into the intake manifold.

A control unit controls the injection amount of first injector 20 and the injection amount of second injector 30 as a function of the load of the internal combustion engine and further operating parameters of the internal combustion engine. In this way, a coupled control of second injection path 7 and of third injection path 8 via shut-off valve 11 and the activation of water pump 10 is possible. In this way, the secondary injector (second injector 30) is configured to optionally inject either water or the fuel. Second injector 30 may be switched on in a partial load phase of the internal combustion engine, the fuel being injected with the aid of second injector 30. In this way, a reduction in the particulate emission is implemented. In addition to operating first injector 20, second injector 30 may be also switched on in a full load phase of the internal combustion engine, water being injected with the aid of second injector 30. The combustion chamber is thereby cooled, so that the efficiency of the internal combustion engine may advantageously be increased in a suitable manner, and the knock resistance increases. During a cold start phase and/or warm-up phase of the internal combustion engine, second injector 30 may be switched on for the injection of the fuel. In this way, an emission reduction is achieved.

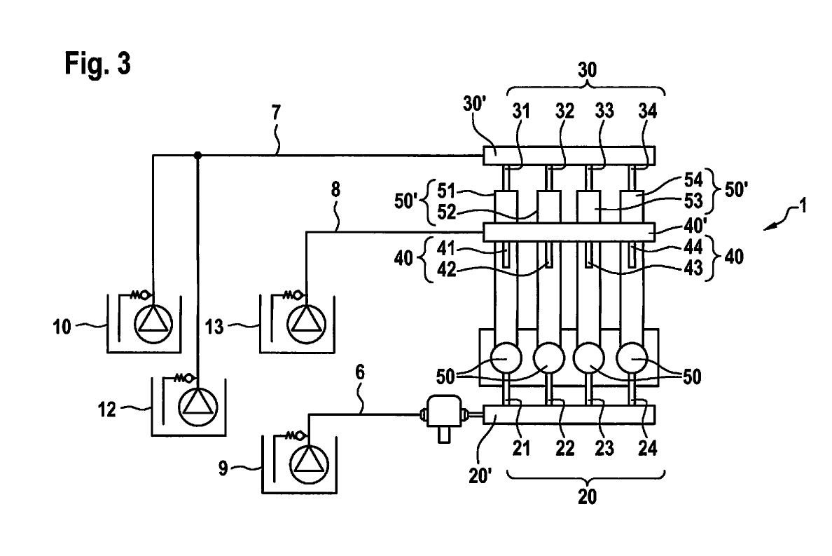

FIG. 3 shows an injection device 1 for an internal combustion engine according to a third exemplary specific embodiment of the present invention. Corresponding to the specific embodiment shown in FIG. 1, the internal combustion engine or injection device 1—per cylinder—includes a third injector 40, in addition to first and second injectors 20, 30, the respective third injector 40 of each cylinder 50 in FIG. 3 being denoted by reference numerals 41, 42, 43 and 44, and these reference numerals being combined by reference numeral 40. Once again, in particular, a third pressure accumulator 40′, from which a stored medium (third fuel) is supplied to the respective third injectors 41, 42, 43, 44, is assigned to the respective third injectors 41, 42, 43, 44. Once again, the internal combustion engine or injection device 1 includes a first injection path 6 for injecting fuel directly into the combustion chamber of a cylinder 50 with the aid of first injector 20. Furthermore, the internal combustion engine or injection device 1 includes a second injection path 7 for the alternative (optional) or combined injection of water or a further fuel (with the aid of second injector 30) into the respective intake manifold 50′ of a cylinder 50, and a third injection path 8 for injecting a third fuel directly into an intake manifold of cylinder 50 or into another intake manifold of cylinder 50 (with the aid of third injector 40). According to the specific embodiment shown in FIG. 3, a gasoline fuel and/or a flex fuel or a CNG fuel or an LPG fuel or an alcohol fuel is provided as fuel (injected directly into the combustion chamber via first injector 20). An ethanol fuel and/or a methanol fuel are provided as further fuel (injected with the aid of second injector 30). A CNG fuel or an LPG fuel or an alcohol fuel (in particular, when a gasoline fuel and/or a flex fuel are used as the fuel) or a gasoline fuel and/or a flex fuel (in particular, when a CNG fuel or an LPG fuel or an alcohol fuel is used as the fuel) is provided as third fuel (injected with the aid of third injector 40). The fuel is supplied to first injection path 6 with the aid of a fuel pump 9. Water is supplied with the aid of a water pump 10, or the further fuel is supplied with the aid of a further fuel pump 12, to second injection path 7. The third fuel is supplied to third injection path 8 with the aid of a third fuel pump 13.

In particular, first injector 20 is a main injector for directly injecting the fuel into the combustion chamber. Second injector 30 is, in particular, a secondary injector for optionally injecting either water or the further fuel into the intake manifold. Third injector 40 is, in particular, a secondary injector for injecting the third fuel into the intake manifold or into the further intake manifold.

A control unit controls the injection amount of first injector 20, the injection amount of second injector 30 and the injection amount of third injector 40 as a function of the load of the internal combustion engine and further operating parameters of the internal combustion engine. The injection of optionally either water or the further fuel with the aid of second injector 30 takes place as a function of the load and further operating parameters. Furthermore, the third fuel is injected via third injector 40 as a function of the operating parameters.

According to one further specific embodiment, first injector 20 is a basic injector for directly injecting a fuel into the combustion chamber. Second injector 30 is a secondary injector for injecting water into the intake manifold. Third injector 40 is a basic injector for injecting the fuel or the further fuel into the intake manifold or into a further intake manifold. Furthermore, cylinder 50 may additionally include a further second injector and/or a further third injector, the further third injector being a basic injector for injecting the fuel or the further fuel into the intake manifold or into the further intake manifold, in particular as a twin injector with the third injector, the further second injector being a secondary injector for injecting water into the intake manifold or into the further intake manifold, in particular as a twin injector with the second injector.

1-10. (canceled)

11. An injection device for an internal combustion engine, the internal combustion engine including a combustion chamber and at least one intake manifold, comprising:
a first injector to inject a fuel directly into the combustion chamber; and
a second injector to inject water into the intake manifold.

12. The injection device of claim 11, wherein the second injector is configured to optionally inject either water or the fuel or a further fuel, or is configured to simultaneously inject both water and the fuel or a further fuel.

13. The injection device of claim 11, wherein the injection device includes a third injector for injecting the fuel or the further fuel or a third fuel into the intake manifold or into a further intake manifold.

14. The injection device of claim 11, wherein: (i) the first injector is a main injector, and both the second and third injectors are secondary injectors, the main injector injecting a larger amount of fuel and/or having a longer operating time than the secondary injector, or (ii) the first and second injectors are secondary injectors and the third injector is a main injector, the main injector injecting a larger amount of fuel and/or having a longer operating time than the secondary injector.

15. The injection device of claim 11, wherein the fuel is a gasoline fuel and/or a flex fuel, and wherein the first injector is configured as the main injector for injecting the fuel and the second injector is configured as the secondary injector for optionally injecting the fuel or for injecting water.

16. The injection device of claim 11, wherein either the fuel is a gasoline fuel and/or a flex fuel, or the fuel is a CNG fuel or an LPG fuel, wherein the first injector is configured as the main injector for injecting the fuel, wherein the second injector is configured as a secondary injector for injecting water, and wherein the third injector is configured as a secondary injector for injecting the fuel.

17. The injection device of claim 11, wherein either the fuel is a gasoline fuel and/or a flex fuel, and the further fuel is a CNG fuel or an LPG fuel, or the fuel is a CNG fuel or an LPG fuel, and the further fuel is a gasoline fuel and/or a flex fuel, and wherein the first injector is configured to inject the fuel, wherein the second injector is configured to inject water, and wherein the third injector is configured to inject the further fuel.

18. The injection device of claim 11, wherein either: (i) the fuel is a gasoline fuel and/or a flex fuel, and the further fuel is an ethanol fuel and/or a methanol fuel, and the third fuel is a CNG fuel or an LPG fuel or an alcohol fuel, or (ii) the fuel is a CNG fuel or an LPG fuel or an alcohol fuel, and the further fuel is an ethanol fuel and/or a methanol fuel, and the third fuel is a gasoline fuel and/or a flex fuel, and wherein the first injector is configured to inject the fuel, wherein the third injector is configured to inject the third fuel, and the second injector is configured to optionally inject the further fuel or to inject water, or is configured to simultaneously inject both water and the further fuel.

19. The injection device of claim 11, wherein a control unit controls the injection amount of the first injector, the injection amount of the second injector and/or the injection amount of the third injector as a function of the load of the internal combustion engine and further operating parameters of the internal combustion engine.

20. The injection device of claim 11, wherein the fuel, the further fuel and the third fuel are one of the following fuels: gasoline, or liquefied petroleum gas, or compressed natural gas, or alcohols, or flex fuel, or gasoline and flex fuel.

21. The injection device of claim 11, wherein the fuel, the further fuel and the third fuel are one of the following fuels: gasoline, or liquefied petroleum gas, or compressed natural gas, or alcohols, including methanol and/or ethanol, or flex fuel, including mixtures of ethanol and gasoline or mixtures of methanol and gasoline, or gasoline and flex fuel.

22. The injection device of claim 11, wherein the fuel, the further fuel and the third fuel are one of the following fuels: gasoline, or liquefied petroleum gas, or compressed natural gas, or alcohols, including methanol and/or ethanol, or flex fuel, including mixtures of ethanol and gasoline, including E0-E85 or E22-E100, or mixtures of methanol and gasoline, including M15-M100, or gasoline and flex fuel.
